(19) United States
(12) Patent Application Publication
(10) Pub. No.: US 2020/0112236 A1
(43) Pub. Date: Apr. 9, 2020

(54) LASER WELDING METHOD FOR STATOR COIL

(71) Applicants: Toyota Jidosha Kabushiki Kaisha, Toyota-shi (JP); Denso Corporation, Kariya-city (JP)

(72) Inventors: Yasuyuki Hirao, Okazaki-shi (JP); Yoshiki Yamauchi, Okazaki-shi (JP); Hiroaki Takeda, Kariya-city (JP); Masaya Nakamura, Kariya-city (JP)

(73) Assignees: Toyota Jidosha Kabushiki Kaisha, Toyota-shi (JP); Denso Corporation, Kariya-city (JP)

(21) Appl. No.: 16/591,935

(22) Filed: Oct. 3, 2019

(30) Foreign Application Priority Data
Oct. 3, 2018 (JP) 2018-188536

(51) Int. Cl. H02K 15/00; H01R 43/02; H01R 4/02; H02K 15/04; B23K 26/08; B23K 26/21; B23K 26/32

(52) U.S. Cl. CPC H02K 15/0068; H01R 43/0221; H01R 4/021; H01R 4/029; B23K 26/32; H02K 15/04; B23K 26/0876; B23K 26/21; H02K 15/0062

(57) ABSTRACT

A laser welding method for a stator coil forms an abutting surface by abutting a side face of a first lead portion of a first rectangular wire to a side face of a second lead portion of a second rectangular wire. A laser beam is focused on a position more inward than a surface of an upper end of the abutting face between the first lead portion and the second lead portion, and the laser beam is moved in a helical loop on the upper end of the abutting face between the first lead portion and the second portion so as to melt the conductor wires to form a molten pool. The molten pool is then moved along the abutting face while the molten pool is continuously formed.

### INCORPORATION BY REFERENCE

The disclosure of Japanese Patent Application No. 2018-188536 filed on Oct. 3, 2018 including the specification, drawings and abstract is incorporated herein by reference in its entirety.

### BACKGROUND

### 1. Technical Field

The present disclosure relates to a laser welding method for a stator coil.

### 2. Description of Related Art

For example, in some stators of three-phase rotating electric machines, a plurality of rectangular wire coils each having a rectangular cross-section is used and wound while being joined to each other in accordance with a predetermined winding method. Laser welding or the like is used in this joining method.

Japanese Patent Application Publication No. 2018-20340 (JP 2018-20340 A) points out that when laser welding is performed on an abutting face between ends of two rectangular coils, a laser beam enters a gap at the abutting face and causes damage to insulating coating of base parts of the ends of the rectangular coils. To cope with this, a molten pool is formed by scanning the inside of the end face apart from the abutting face of the rectangular wire on one side with a laser beam in an annular or helical loop, and the loop diameter is increased to increase the diameter of the molten pool, to reach a side face of the end so as to fill the gap with the molten pool. By filling the gap with the molten pool, the laser beam is prevented from entering the gap. Here, it is described that a laser reflected light from a laser irradiation surface and fluctuations in plasma are detected by using an optical system, and when they change suddenly, sputtering is caused.

As a related art of JP 2018-20340 A, Japanese Patent Application Publication No. 2018-30155 discloses a method for suppressing bias of amount of laser input heat between the ends of two rectangular wires that are abutted to each other. In this case, a molten pool is formed in an end face of one rectangular wire while being expanded until reaching the side face of this end, and then is cooled; and thereafter, a molten pool is formed in an end face of the other rectangular wire while being expanded until reaching the side face of this end, and then is cooled.

### SUMMARY

It is conceivable that sputtering due to a sudden change of a laser reflected light or plasma from a laser irradiation surface is caused by local heating on a laser irradiation surface. As one example, local heating is caused on a laser irradiation surface in the case of “just focus” that a focus position of the laser is on the irradiation surface.

In the case of the just focus, an irradiation energy density on the irradiation surface is high, and thus local heating is likely to be caused at a coil edge or the like, for example. Even at a part other than a coil edge or the like, a sudden phase change in solid phase, liquid phase, or gas phase may randomly occur on the irradiated surface until the molten pool is sufficiently grown. In order to avoid this, there is a method for forming a molten pool at a position apart from an abutting face, and a laser irradiation loop diameter is gradually increased to bring the molten pool to reach a joint face; however, the irradiation trajectory becomes longer, which makes the processing time for the joint longer.

Further, when a laser output is gradually increased from an initial value to a maximum output value, stepwise increase of the laser output causes local heating due to a great sudden change in output at a discontinuity point of each step.

When local heating is caused on a laser irradiation surface, a large amount of sputtering is scattered, which results in deterioration of the welding quality. Therefore, there is a demand for a laser welding method for a stator coil that can reduce scatters of sputtering by reducing local heating on a laser irradiation surface.

A laser welding method for a stator coil according to the present disclosure, includes: forming an abutting face by abutting a side face of a first lead portion of a first rectangular wire to a side face of a second rectangular wire of a second lead portion, the first rectangular wire and the second rectangular wire being conductor wires formed of conductor strands each having a rectangular cross-section and being covered with an insulation film, the insulation film at the side face of the first lead portion being peeled off and the insulation film at the side face of the second lead portion being peeled off; defocusing of focusing a laser beam on a position more inward than a surface of an upper end of the abutting face between the first lead portion and the second lead portion; forming a molten pool by moving the laser beam in an annular or helical loop on the upper end of the abutting face between the first lead portion and the second lead portion so as to melt the conductor wires to form the molten pool at a position closer to the upper end of the abutting face; and moving the molten pool along the abutting face while continuously forming the molten pool, wherein in the formation of the molten pool, when a position of a defocus depth of the laser beam is changed with time and when an output of the laser beam is changed with time, both of the position of the defocus depth and the output of the laser beam are changed continuously.

According to the above configuration, since the laser beam is focused on a position more inward than the surface of the upper end of the abutting face, the laser irradiation spot diameter on the surface of the upper end of the abutting face becomes larger than that in the case of just focus, and thus the irradiation energy density of the laser beam can be reduced. In addition, since the focus depth position and the laser output of the laser beam are continuously and smoothly changed, local heating on the laser irradiation surface can be reduced. Moreover, since the laser irradiation spot diameter is larger, it is possible, without increasing the loop diameter, to move the molten pool along the abutting face while continuously forming the molten pool, to join the side faces; and compared with the case of gradually increasing the loop diameter, the irradiation trajectory is shorter, to thus shorten the processing time for the joining.

According to the laser welding method for the stator coil having the above-described configuration, it is possible to reduce scatters of sputtering by reducing local heating on the laser irradiation surface.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view showing a coil end of a stator of a rotating electric machine to which a laser welding method for a stator coil according to an embodiment is applied;

FIG. 2A is a view of a segment coil used in FIG. 1, and is an overall view thereof;

FIG. 2B is a view of a segment coil used in FIG. 1, and is an enlarged sectional view of a part B in FIG. 2A;

FIG. 3A is a view showing a part C extracted from FIG. 1, and is a view showing a state before respective lead portions of two rectangular wires are abutted to each other;

FIG. 3B is a view showing the part C extracted from FIG. 1, and is a view showing a state in which side faces of the respective lead portions of the two rectangular wires are abutted to each other;

FIG. 4 is a flowchart showing a procedure of a laser welding method for a stator coil according to the embodiment;

FIG. 5A is a view showing a defocusing step in FIG. 4, and is a perspective view thereof;

FIG. 5B is a view showing the defocusing step in FIG. 4, and is a sectional view taken along the radial direction;

FIG. 6 is a flowchart showing a detailed procedure of a molten pool forming step in FIG. 4;

FIG. 7A is a view showing an example in which laser output is continuously changed in FIG. 6, FIG. 7A has a horizontal axis representing time and a vertical axis representing the laser output, and is a view showing two examples of continuous change of the laser output;

FIG. 7B is a view showing the example in which the laser output is continuously changed in FIG. 6, FIG. 7B has a horizontal axis representing time and a vertical axis representing the laser output, and is a view showing two examples of continuous change of the laser output;

FIG. 7C is a view showing the example in which the laser output is continuously changed in FIG. 6, FIG. 7C has a horizontal axis representing time and a vertical axis representing the laser output, and is a view showing that the laser output is changed stepwise and discontinuously, as a comparative example;

FIG. 8A is a view showing an example in which the focus position of a laser beam is continuously changed from defocus to just focus in FIG. 6, and is a perspective view of an abutting face on which a molten pool is formed;

FIG. 8B is a view showing the example in which the focus position of the laser beam is continuously changed from defocus to just focus in FIG. 6, and is a sectional view taken along a plane E of FIG. 8A, and showing an initial defocus position;

FIG. 8C is a view showing the example in which the focus position of the laser beam is continuously changed from defocus to just focus in FIG. 6, and is a sectional view taken along the plane E of FIG. 8A, and showing the just focus position;

FIG. 9A is a view showing a modification of FIG. 8A to FIG. 8C, and showing an example in which the focus position of the laser beam is continuously changed from an initial defocus toward the just focus side to reach a defocus position closer to the just focus, and is a perspective view showing an abutting face on which a molten pool is formed;

FIG. 9B is a view showing the modification of FIG. 8A to FIG. 8C, and showing the example in which the focus position of the laser beam is continuously changed from the initial defocus toward the just focus side to reach the defocus position closer to the just focus, and is a sectional view taken along a plane E of FIG. 9A, and showing the initial defocus position;

FIG. 9C is a view showing the modification of FIG. 8A to FIG. 8C, and is a view showing the example in which the focus position of the laser beam is continuously changed from the initial defocus toward the just focus side to reach the defocus position closer to the just focus, and is a sectional view taken along plane E in FIG. 9A, and showing a state in which the focus position of the laser beam is changed to the defocus position closer to the just focus;

FIG. 10A is a view showing, as an example of the molten pool moving step of FIG. 4, an example of moving the molten pool while continuously forming the molten pool along the abutting face with the focus position of the laser beam maintained to the defocus, and

FIG. 10A is a perspective view showing the movement of the molten pool; and

FIG. 10B is a view showing, as an example of the molten pool moving step of FIG. 4, an example of moving the molten pool while continuously forming the molten pool along the abutting face with the focus position of the laser beam maintained to the defocus, and FIG. 10B is a sectional view taken along the radial direction.

### DETAILED DESCRIPTION OF EMBODIMENTS

Hereinafter, embodiments according to the present disclosure will be described below in detail with reference to the drawings. In the following description, a stator winding of a three-phase rotating electrical machine will be described as an object to which the laser welding method for the stator coil is applied; however, this is an illustrative example. As far as two rectangular wires are laser-welded to each other, it can be similarly applied to a stator winding for other than a three-phase rotating electric machine.

Below, description will be provided on a segment coil as a stator winding of a three-phase rotating electrical machine; however, this is an illustrative example, and a concentrated winding coil or the like may be used.

Shapes, dimensions, materials, and the like described below are examples for explanation, and can be appropriately changed according to the specifications of the laser welding method for the stator coil. Hereinafter, the same reference numerals are attached to the same elements in all the drawings, and overlapping description thereof will be omitted.

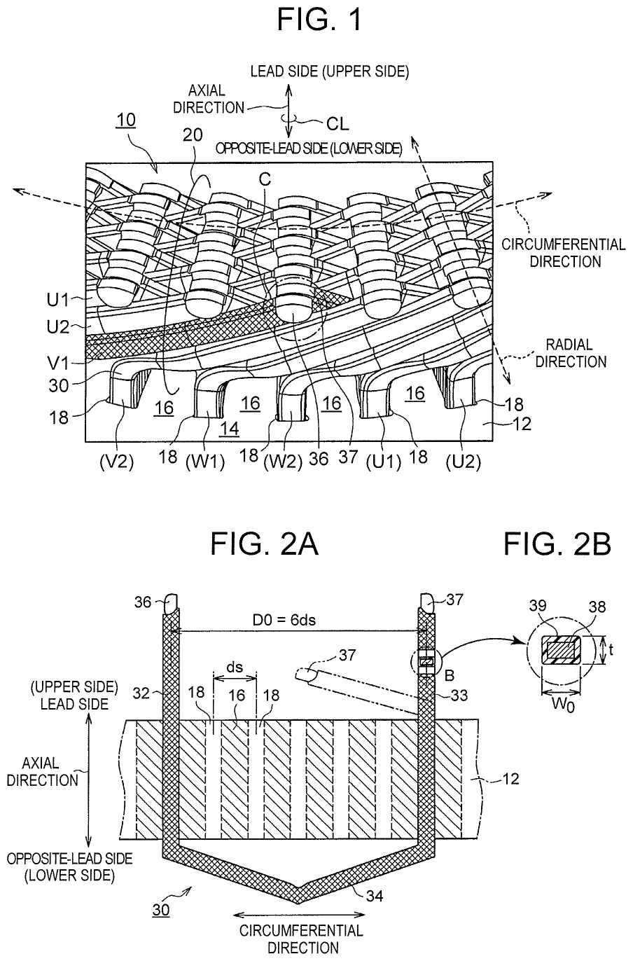

FIG. 1 are views each showing a coil end as a configuration of a stator 10 of a rotating electrical machine to which the laser welding method for a stator coil is applied. Hereinafter, unless otherwise specified, the stator 10 of the rotating electrical machine is referred to as a stator 10. The rotating electrical machine using the stator 10 is a rotating electrical machine mounted in an electric vehicle. The rotating electric machine is a three-phase synchronous rotating electric machine that functions as an electric motor when the electric vehicle is powered, and functions as an electric power generator when the electric vehicle is in a braking state. The rotating electrical machine includes: the stator 10 shown in FIG. 1; and a rotor disposed inward of the stator 10 with a predetermined distance therebetween. In FIG. 1, an illustration of the rotor is omitted. The stator 10 includes: a stator core 12; and a stator winding 20.

FIG. 1 shows an axial direction, a radial direction, and a circumferential direction. The axial direction is a direction along a central axis CL of a central hole of the stator core 12, and a direction in which a power line lead is drawn out in the stator winding is a lead side, and an opposite side to this side is an opposite-lead side. As laser welding is performed with the lead side positioned upward; therefore, in the following, the lead side will be referred to as the upper side and the opposite-lead side will be referred to as the lower side, depending on the situation. The radial direction is a direction radially passing through the central axis CL in a plane perpendicular to the axial direction, and the circumferential direction is a direction along the circumferential direction about the central axis CL.

The stator core 12 is a magnetic component having a central hole in which the rotor is disposed, and includes an annular back yoke 14 and a plurality of teeth 16 protruding from the back yoke 14 toward the inner circumferential side. A space between two adjacent teeth 16 is a slot 18. The number of teeth 16 and the number of slots 18 are the same, and both are multiples of 3.

This stator core 12 includes the back yoke 14 and the teeth 16, and is a laminated body formed of a predetermined number of annular magnetic thin plates that is formed in a predetermined shape and stacked in the axial direction so as to form the slots 18. Both surfaces of each magnetic thin plate are electrically insulated. As a material of the magnetic thin plates, an electromagnetic steel plate which is a type of a silicon steel plate can be used. Instead of the laminated body of the magnetic thin plates, the stator core 12 may be formed by integrally molding magnetic powder.

The stator winding 20 is a three-phase distributed winding coil, and is formed by winding a single phase winding wire across the plurality of teeth 16. Each phase winding is distributedly wound by two turns; therefore, for distinguishing the respective turns, a U-phase winding is called as a U1 winding and a U2 winding, a V-phase winding is called as a V1 winding and a V2 winding, and a W-phase winding is called as a W1 winding and a W2 winding. The stator winding 20 is wound in every single set of the U1 winding, the U2 winding, the V1 winding, the V2 winding, the W1 winding, and the W2 winding, along the circumferential direction of the stator core 12. The windings of the respective phases inserted into the slots 18 shown in FIG. 1 are indicated by V2, W1, W2, U1 in parentheses. Therefore, the same phase windings are sequentially inserted into the slots 18 with being spaced by 6 slots and wound by one turn around the stator core 12 in the circumferential direction. In other words, each single phase winding wire is wound across the six teeth 16.

The stator winding 20 is wound around the teeth 16 of the stator core 12 using a plurality of segment coils 30. FIG. 2A, FIG. 2B are views showing the segment coil 30. FIG. 2A is a front view when having a face defined by the axial direction and the circumferential direction as the front face.

Each segment coil 30 is a conductor wire with an insulation film, which is formed of a conductor wire 38 having a rectangular cross section, covered with the insulation film excluding both ends thereof, and formed in a predetermined shape. As the conductor wire 38 of the conductor wire with an insulation film, a copper wire, a copper tin alloy wire, a silver-plated copper tin alloy wire, or the like may be used. As the insulating film 39, a polyamide-imide enamel film may be used.

The segment coil 30 has a substantially U-shape. As shown in FIG. 2A, FIG. 2B, the long-side face of the rectangular cross section of the rectangular wire is a substantially U-shaped front face, and the short-side face is a side face. The substantially U-shape is formed by edgewise bending that bends the short-side face.

The segment coil 30 having a substantially U-shape includes: two parallel legs 32, 33 at both ends in the axial direction, each of the legs having a linear portion inserted into the slot 18 of the stator core 12; and a bent-shaped turn portion 34 that connects one ends of the legs 32, 33. A distance between the two parallel legs 32, 33 is a length by 6 slots. If a distance for one slot is defined as ds, the distance D0 between the two parallel legs 32, 33 is D0=6 ds. Front ends of the legs 32, 33 are lead portions 36, in which their insulating films 39 are peeled off and the conductor wires 38 are exposed.

FIG. 2B is an enlarged view of a rectangular cross section of a part B of the segment coil 30 excluding the vicinities of the respective lead portions 36, 37 of the legs 32, 33. The part B has a width dimension W0 that is a longer side of the rectangular cross section as a width, and a thickness dimension t that is a shorter side thereof as a thickness. Here, W0>t is satisfied.

When the stator winding 20 is formed using the segment coils 30, each of the segment coils 30 has the two parallel legs 32, 33 in the two slots 18 distant from each other by D0=6 ds along the circumferential direction of the stator core 12. The insertion of the legs is performed from an end face on the opposite-lead side of the stator core 12, and the ends including the lead portions 36, 37 protrude from the end face on the lead side of the stator core 12. The protruding lead portions 36, 37 are appropriately bent on the outer side of the end face on the lead side of the stator core 12. FIG. 2A shows a state of the leg 33 being bent, as indicated by a dashed-two dotted line. The leg 32 is also bent in the same manner in the opposite bending direction. The bent lead portions 36, 37 are joined respectively to lead portions 37, 36 of a different segment coil 30. Parts of the lead portions 36, 37 that are bent and joined to the lead portions 37, 36 of another segment coil by welding or the like according to a predetermined winding method becomes the coil end on the lead side in the stator winding 20. The turn portion 34 of the segment coil 30 inserted in the stator core 12 is located on the opposite-lead side of the stator core 12 and becomes a coil end on the opposite-lead side.

The laser welding method for the stator coil is a method of joining, using a laser beam, the lead portion 37 at the front end of the leg 33 bent in the segment coil 30 shown in FIG. 2A to the lead portion 36 at the front end of the leg 32 bent in another segment coil 30 not shown in FIG. 2A. In FIG. 1, one of portions to which the stator coil laser welding method is applied is indicated by a one-dot chain line as a part C. Assuming that the segment coil 30 of FIG. 2A is the segment coil 30 on one side of the V1-phase winding, the part C is a part where the lead portion 37 of the segment coil 30 on one side and the lead portion 36 of the segment coil 30 on the other side (not shown in FIG. 2A) are joined to each other. In the following description, the laser welding method on the part C of FIG. 1 will be described.

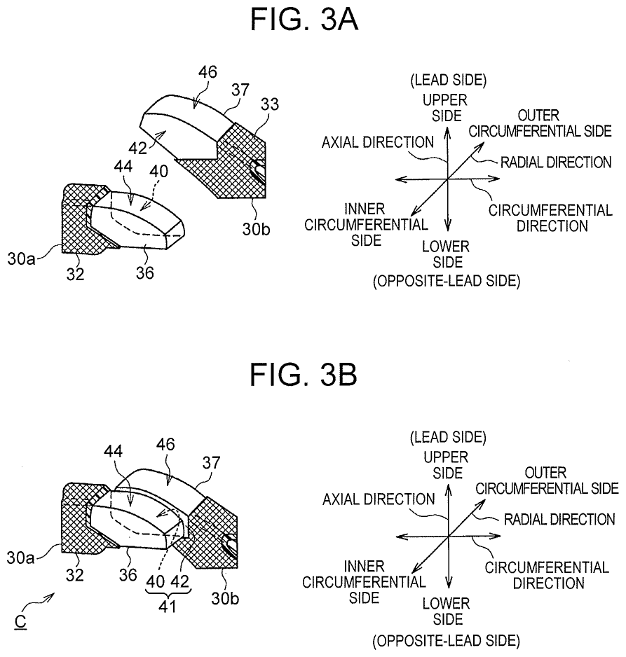

FIG. 3A, FIG. 3B are views each showing the part C extracted from FIG. 1. In the following description, since the segment coil is a rectangular wire, in order to distinguish the two segment coils to be joined, one is referred to as a first rectangular wire 30a and the other is referred to as a second rectangular wire 30b. The first rectangular wire 30a corresponds to the other segment coil 30 (not shown in FIG. 2A), and the second rectangular wire 30b corresponds to the one segment coil 30 in FIG. 2A.

FIG. 3A is a view showing a state before the lead portion 36 of the first rectangular wire 30a and the lead portion 37 of the second rectangular wire 30b are abutted to each other. In the lead portion 36, a radially outer side face 40 is a side face facing the lead portion 37; and in the lead portion 37, a radially inner side face 42 is a side face facing the lead portion 36. In the lead portions 36, 37, respective upper end faces are upper end faces 44, 46.

FIG. 3B is a view showing a state in which the lead portion 36 of the first rectangular wire 30a and the lead portion 37 of the second rectangular wire 30b are abutted to each other, and this view corresponds to the part C extracted from FIG. 1. In this abutting, the side face 40 of the lead portion 36 of the first rectangular wire 30a is abutted to the side face 42 of the lead portion 37 of the second rectangular wire 30b. An abutting face 41 is a face at which the side faces 40, 42 are in contact with each other. An upper end of the abutting face 41 has substantially the same height as the axial heights of the upper end faces 44, 46 of the lead portions 36, 37.

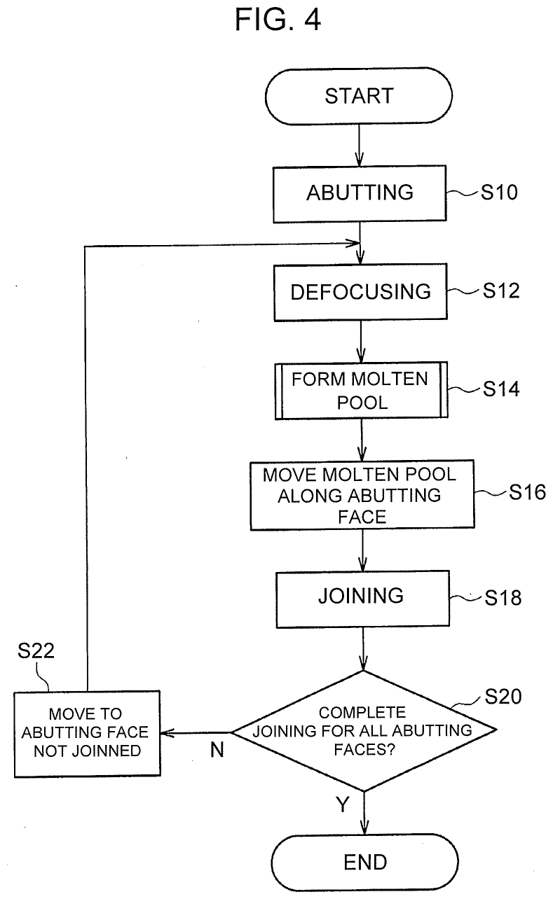

FIG. 4 is a flowchart showing the procedure of the laser welding method for the stator coil. The first step is an abutting step (S10). The abutting step is a step of performing the processing described in FIG. 3A, FIG. 3B. In this step, in the first rectangular wire 30a and the second rectangular wire 30b, the side faces 40, 42 of the first lead portion 36 and the second lead portion 37 with the insulating film 39 peeled off are abutted to each other to form the abutting face 41. This step is carried out as a part of the assembly process of the stator 10 of the rotating electrical machine.

Following the abutting step, a laser welding apparatus is used. The laser welding apparatus includes a laser light source, an optical system, a laser fiber that guides a laser light to a laser head, and a control unit that performs control to emit a laser beam from the laser head and move this laser beam position to a predetermined position. This control includes a laser output control, a setting control on a laser-beam focus position, a control on laser beam movement, etc.

When the laser welding apparatus is started up, initialization is executed. Operating conditions, such as a laser output, an optical system magnification, a moving irradiating speed, and a defocus position described later, are set in predetermined standard conditions. In addition, as determination conditions to be executed in a molten pool forming step described later, specifications of the first rectangular wire 30a and the second rectangular wire 30b, particularly a heat capacity and the like, are input. As for the heat capacity, although an actual numerical value may be input, classifications of “large”, “medium”, and “small” may be input according to a predetermined standard. Hereinafter, the heat capacity will be described using three classifications of “large”, “medium”, and “small”. This is an example for explanation, and conditions regarding specifications other than this may be input.

When the initialization is completed, a defocusing step is performed for focusing the laser beam on the inner side under the surface of the upper face of the abutting face 41 between the first lead portion 36 and the second lead portion 37 (S12). Defocusing means shifting a focus position from the surface of a target object toward the upper side or the lower side from a just focus that focuses the laser beam on the surface of the target object. Here, employed is lower focusing in which the focus position is set on the inner side lower than the surface of the target object. In the following description, unless otherwise specified, defocusing refers to as lower focusing.

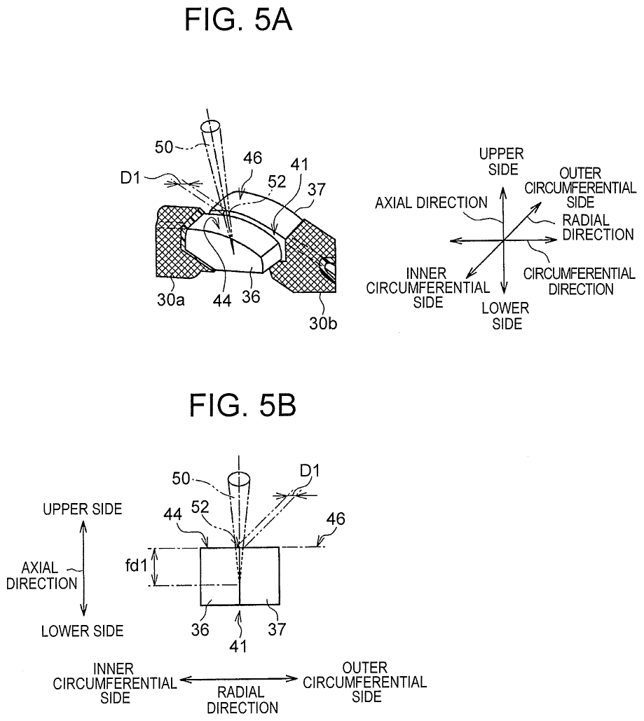

FIG. 5A, FIG. 5B show details of the defocusing step. FIG. 5A is a perspective view corresponding to FIG. 3B, and FIG. 5B is sectional view along the radial direction. Since the defocusing step is a setting step of the focus position of the laser beam, the abutting face 41 is not irradiated with the laser beam; however, for convenience of explanation, the laser beam 50 set at the defocus position is indicated by a two-dot chain line.

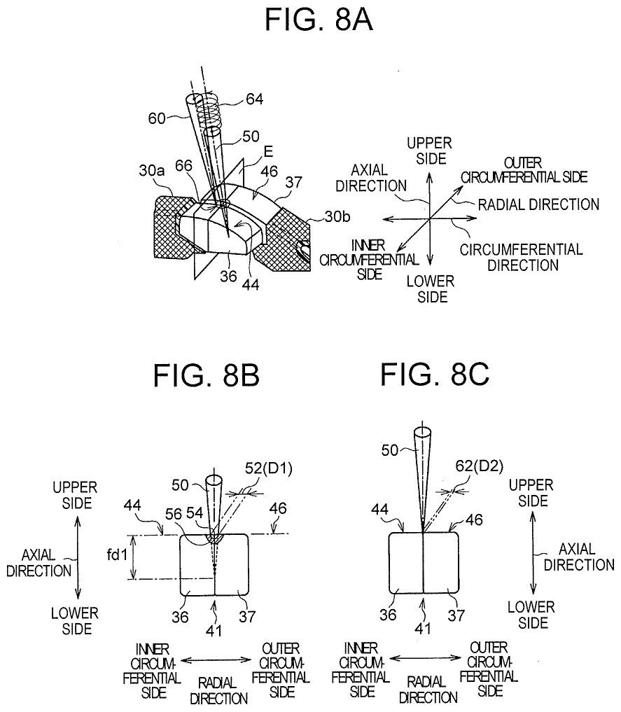

The irradiation position with the laser beam 50 is set on the upper end of the abutting face 41. The laser beam 50 is focused on a position fd1 located lower than the upper end of the abutting face 41, and an irradiation region 52 on the upper end of the abutting face 41 includes a laser irradiation spot diameter D1. Since the just focusing focuses the laser beam on a position of the upper end of the abutting face 41, a laser irradiation spot diameter D2 (see FIG. 8A to FIG. 8C) in the case of the just focus is very small, and thus the irradiation energy density is high. Since the focus position of the laser beam 50 is set to the defocus position, the laser irradiation spot diameter D1 is larger than the laser irradiation spot diameter D2 at the just focus position. Thereby, the irradiation energy density of the laser beam 50 on the upper end of the abutting face 41 can be lowered than that in the case of just focus. The laser irradiation spot diameter D1 can be set to a desired diameter by appropriately selecting the fiber cable diameter of the laser and the magnification of the optical system in the laser welding apparatus.

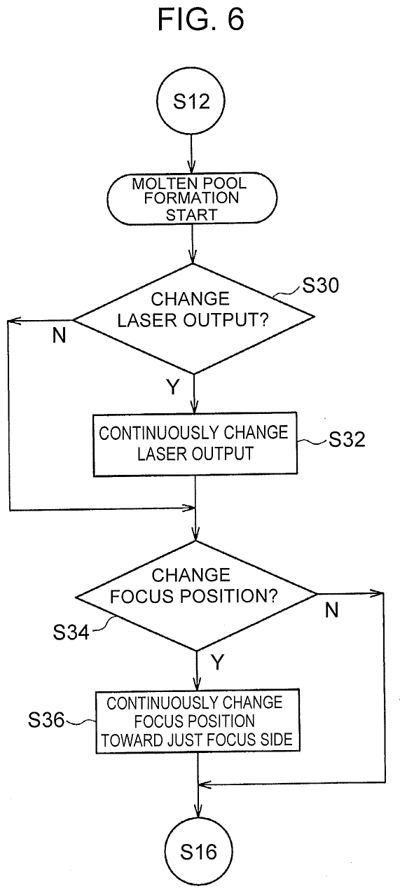

Following the defocusing step, the molten pool forming step (S14) is performed, and in this molten pool forming step, the laser beam is moved in an annular or helical loop on the upper end of the abutting face 41 between the first lead portion 36 and the second lead portion 37 so as to form a molten pool in which the conductor wire 38 is melted on the upper end of the abutting face 41. The molten pool forming step is a step of forming a molten pool having a diameter and a depth enough for joining the first lead portion 36 and the second lead portion 37 at the abutting face 41. Detailed description on the molten pool forming step will be provided later with reference to FIG. 6.

Subsequent to the molten pool forming step, a molten pool moving step (S16) is performed, and in this molten pool moving step, the molten pool is moved while the molten pool is continuously formed along the abutting face 41. In this step, the first lead portion 36 and the second lead portion 37 are joined to each other at the abutting face (S18). Then, it is determined whether or not the joining has been performed for all the abutting faces 41 (S20). If the determination is negative, the laser head is moved to an abutting face 41 not joined yet (S22), and then the process returns to S12 for repeating the above processing procedure. If the determination in S20 is affirmative, all the procedures of the laser welding method for the stator coil are completed.

FIG. 6 is a flowchart showing a detailed procedure of the molten pool forming step. In the molten pool forming step, according to the specifications of the stator 10, in particular, according to the joint quality specifications of the first lead portion and the second lead portion 37, settings regarding the laser output for forming a molten pool having an appropriate diameter and an appropriate depth as well as settings regarding the focus position of the laser beam are carried out. Examples of the joint quality may include a joint strength and reduction of scatters of sputtering in the welding joint. These rely on the heat capacity of the first rectangular wire 30a and the second rectangular wire 30b. In the following description, detailed description will be provided on the welding pool formation step.

First, it is determined whether or not to change the laser output (S30). An appropriate laser output is required for forming a molten pool. When the heat capacity of the first rectangular wire 30a and the second rectangular wire 30b is “small”, the laser output required for forming the molten pool is not so large. In this case, it is possible to set a necessary laser output from the beginning of the laser beam irradiation, and thus the determination in S30 is negative. If the determination in S30 is negative, there is no need to change the laser output, and thus the process then proceeds to S34.

To the contrary, if the heat capacity of the first rectangular wire 30a and the second rectangular wire 30b is “medium” or “large”, a considerably large laser output is required. In this case, it is preferable to gradually increase the laser output without using a large laser output from the beginning of the laser beam irradiation. Therefore, since it is necessary to change the laser output, the determination in S30 is affirmative. If the determination in S30 is affirmative, the process proceeds to S32. Even in the case of gradually increase the laser output, if the laser output is gradually increased stepwise, local heating due to a great sudden change in output may occur at a discontinuity point of each step. To cope with this, setting for continuously changing the laser output is performed (S32). Continuously changing the laser output means changing the laser output smoothly with time without changing the laser output stepwise with time.

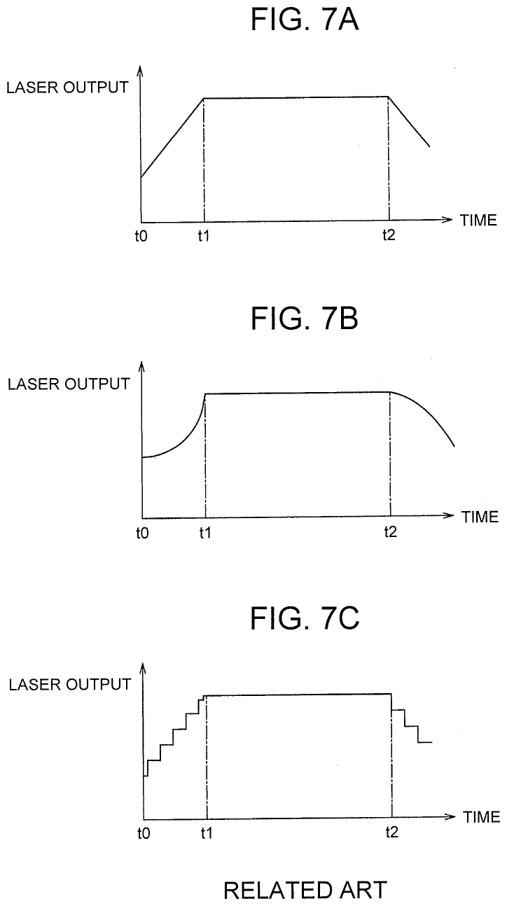

In FIG. 7A, FIG. 7B, FIG. 7C, the setting for changing the laser output with time is exemplified. In each of FIG. 7A, FIG. 7B, FIG. 7C, the horizontal axis represents time, and the vertical axis represents the laser output. Time t0 is an irradiation start time of the laser beam. A period from time t0 to time t1 is a molten pool formation period. A period from time t1 to time t2 is a molten pool moving period. A period after time t2 is a period in which the laser beam irradiation is stopped and the molten pool is solidified.

FIG. 7A, FIG. 7B are views showing two examples of the setting of continuously changing the laser output during the weld pool formation period. FIG. 7A shows an example of the setting of linearly increasing the laser output from time t0 to time t1. FIG. 7B shows an example of the setting of increasing the laser output in a multi-order function. When the heat capacity is “medium” or “large”, the setting in FIG. 7A or FIG. 7B is carried out.

FIG. 7C is a view showing the case of the setting of discontinuously changing the laser output stepwise, as a comparative example. When the laser output is gradually increased stepwise, a great sudden change in laser output occurs at a discontinuity point of each step; consequently, local heating may occur during the process of forming a molten pool due to a sudden change in laser output. Occurrence of local heating increases scatters of sputtering. To the contrary, in FIG. 7A, FIG. 7B, since the laser output changes continuously with time, the occurrence of local heating is suppressed, and thus scatters of sputtering can be reduced.

Returning to FIG. 6, in S34, it is determined whether or not to change the focus position. When the laser beam 50 at the defocus position described in S12 is actually applied, the irradiation energy density in the irradiation region 52 on the upper end of the abutting face 41 is lower than the irradiation energy density in the case of the just focusing. For example, in the case in which the heat capacity of the rectangular wires 30a, 30b is “small”, even though a sufficient joint at the abutting face 41 is provided by a molten pool 56 formed by irradiation with the laser beam 50 at the defocus position, the joining may not be sufficient when the heat capacity is “large” or “medium”. For this reason, the determination in S34 is made. If the determination in S34 is negative, the focus position remains at the defocus position and is not changed, and the process proceeds to S16. If the determination in S34 is affirmative, the process proceeds to S36, and the setting of continuously changing the focus position from the defocus position toward the just focus position is performed.

In FIG. 8A to FIG. 8C, the laser beam 50 having a focus depth at the defocus position and the laser beam 60 having a focus depth shifted to the just focus position are shown. FIG. 8A is a perspective view corresponding to FIG. 3B, and FIG. 8B, FIG. 8C are sectional views along a plane E of FIG. 8A.

FIG. 8B is a view corresponding to FIG. 5B, showing the laser beam 50 having a focus depth at the defocus position. The laser beam 50 is focused on a position fd1 located lower than the upper end of the abutting face 41, and the irradiation region 52 on the upper end of the abutting face 41 has a laser irradiation spot diameter D1. When the upper end of the abutting face 41 between the first lead portion 36 and the second lead portion 37 is actually irradiated with the laser beam 50, a recess 54 called as a keyhole is formed by the irradiation with the laser beam 50 immediately under the irradiation region 52, and the molten pool 56 is formed around this recess 54.

FIG. 8C shows the laser beam 60 having a focus depth at the just focus position. Since the laser beam 60 is focused on the position in the upper end of the abutting face 41, the laser irradiation spot diameter D2 in an irradiation region 62 is very small and the irradiation energy density is thus higher. On the other hand, since the laser irradiation spot diameter D1 of the defocused laser beam 50 in FIG. 8B is larger than D2, the irradiation energy density is thus lower. Therefore, when the heat capacity of the rectangular wires 30a and 30b is “large”, the molten pool 56 described in FIG. 8B cannot be grown to a size sufficient for the joint. To cope with this, as shown in FIG. 8A, the laser beam 60 is continuously pulled upward. Thereby, the irradiation region on the upper end of the abutting face 41 becomes gradually smaller, and the irradiation energy density becomes gradually higher.

When the laser beam 50 at the defocus position is continuously pulled upward to be the laser beam 60 at the just focus position, the laser beam 50 is pulled upward not linearly and continuously but in a helical loop trajectory. FIG. 8A shows a helical loop trajectory 64 having an upward moving direction. The reason why the helical loop trajectory 64 is used is because the conductor wire 38 is made of a metal material having a high thermal conductivity, such as a copper wire, and is excellent in thermal conductivity; therefore, the conductor wire 38 is solidified immediately after being melted by the laser irradiation, which makes it difficult to maintain its molten state. With this configuration, at the position of the upper end of the abutting face 41, the molten state is maintained by the laser irradiation, and the molten pool 66 is thus formed.

In the above description, the helical loop trajectory 64 has been described; however, the basic helical shape may be any shape in a smooth trajectory, and thus the helical shape may be circular or elliptical.

The formation of the molten pool 66 is performed under a condition that the irradiation energy density is continuously and gradually changed from a state where the irradiation energy density with the laser beam 50 is lower at the defocus position to a state where the irradiation energy density with the laser beam 60 is higher at the just focus position. As a result, no sudden change in irradiation energy density occurs at the position of the upper end of the abutting face 41, which suppresses random occurrence of the phase change between the solid phase, the liquid phase, and the gas phase of a copper wire or the like as the conductor wire 38. Accordingly, it is possible to reduce occurrence of sputtering at the coil edge or the like, which is likely to be locally heated. Thus, while reducing occurrence of sputtering, it is possible to increase the irradiation energy density on the upper end of the abutting face 41, and whereby the molten pool 66 can be grown to have a diameter and a depth enough for the joint at the abutting face 41.

Initially, since the laser beam 50 starts at the defocus position, after the recess 54 that is the keyhole described in FIG. 8A is formed, the laser beam is condensed in the recess 54 that is the keyhole. Accordingly, the depth of the molten pool 66 can be made deeper than that in the case of using the upper focus from the beginning, or the like. Furthermore, since the laser irradiation spot diameter on the upper end of the abutting face can be made larger at the defocus position than at the just focus position, the diameter of a loop orbit can be smaller while the diameter of the molten pool 66 is maintained, which makes it possible to shorten the processing time for the joint.

In the above description, the focus depth is continuously changed toward the just focus. When the heat capacity of the rectangular wires 30a, 30b is “medium”, it is not always necessary to pull up the laser beam to the just focus position, but alternatively, the pull-up of the laser beam may be stopped at an upper middle position to the “just focus side”.

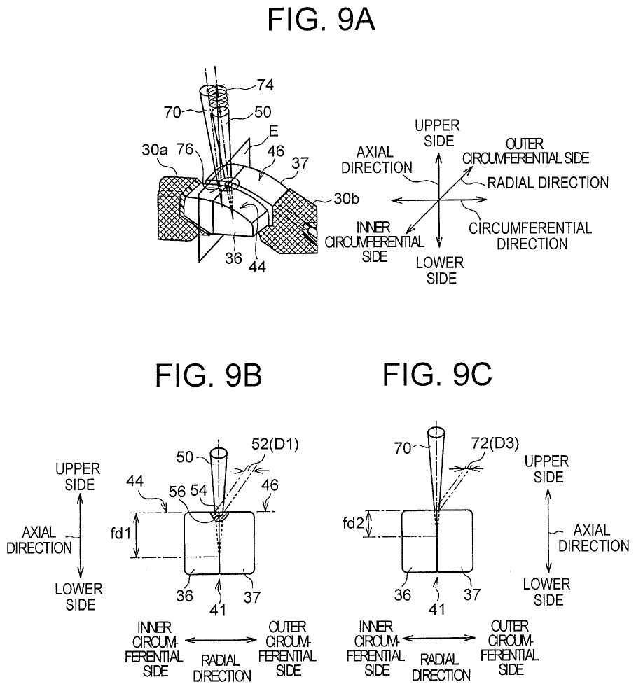

FIG. 9A to FIG. 9C is a modification of FIG. 8A to FIG. 8C, and shows an example that the focus position of the laser beam is continuously changed from the initial defocus position toward the just focus side, to reach a defocus position close to the just focus. FIG. 9A is a perspective view corresponding to FIG. 8A, and FIG. 9B, FIG. 9C are sectional views taken along the plane E FIG. 9A. FIG. 9B is a view corresponding to FIG. 8B, and shows the laser beam 50 having a focus depth at a defocus position. FIG. 9C shows a laser beam 70 having a focus depth at a defocus position closer to the just focus.

As shown in FIG. 9C, the laser beam 70 is focused on a position fd2 at a position located lower than the upper end of the abutting face 41, and an irradiation region in the upper end of the abutting face 41 has a laser irradiation spot diameter D3. Compared to FIG. 8A to FIG. 8C, fd2<fd1 and D1>D3>D2 are satisfied.

As shown in FIG. 9A, in the case of continuously pulling up the laser beam 50 located at the defocus position to the laser beam 70 located at a defocus position closer to the just focus, the laser beam 50 is pulled up in a helical loop trajectory 74 drawn upward. FIG. 7A shows a grown molten pool 76.

Since the laser irradiation spot diameter D3 of the laser beam 70 is larger than D2, the irradiation energy density is lower than that of the just focused laser beam 60; however, if the heat capacity of the rectangular wires 30a, 30b is “medium”, the joint at the abutting face 41 can be carried out by the molten pool 76.

Returning to FIG. 6, if the determination in S34 is negative, the focus position of the laser beam is not changed and stays at the defocus position, and the process proceeds to S16. When the heat capacity of the rectangular wires 30a, 30b is “small”, the determination in S34 is negative; thus, the process proceeds to S16 in a state in which the molten pool 56 described in FIG. 8B is formed.

In the molten pool forming step, since there are two determination processes of S30 and S34, there are four cases: “negative in both S30 and S34” “positive in S30 and negative in S34”, “negative in S30 and positive in S34”, and “positive in both S30 and S34”. If “positive in both S30 and S34”, the determination in S32 and the determination in S36 are executed in parallel. That is, the laser output is changed, at the same time, the focus position is changed.

Note that it is conceivable to adjust the irradiation energy density in order to suppress scatters of sputtering only by adjusting the laser output. In this case, it is necessary to gradually change the laser output over time, and the processing time required for the joint becomes longer. In addition, a long-time laser irradiation over time causes an unintended focus drift due to increase in temperature in the optical system, or the like; therefore, an unintended change in irradiation energy density may be induced.

Returning to FIG. 4, after the molten pool forming step (S14) is completed, the process then proceeds to the molten pool moving step of moving the molten pool along the abutting face 41. The continuous movement of the molten pool along the abutting face 41 is as follows: in the case of the heat capacity of the rectangular wires 30a, 30b being “large”, the molten pool 66 described in FIG. 8A moves, in the case of the heat capacity being “medium”, the molten pool 76 described in FIG. 9A moves, and in the case of the heat capacity being “small”, the molten pool 56 described in FIG. 8B moves, continuously along the abutting face 41, respectively.

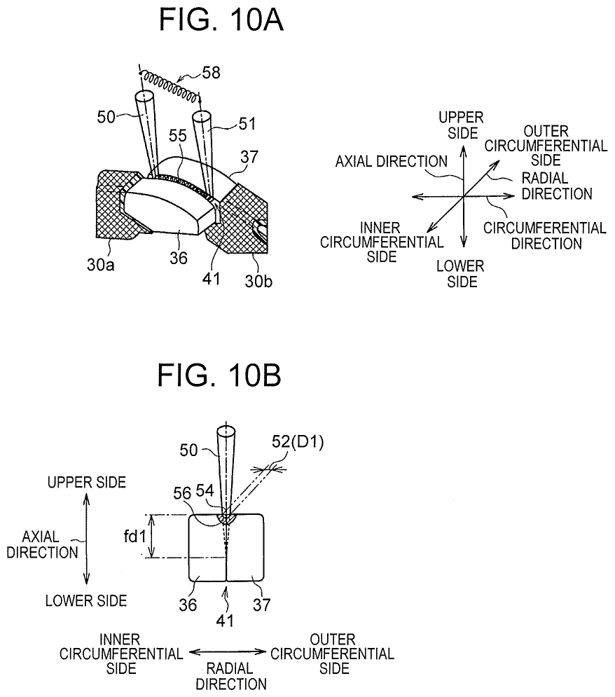

As an example of the molten pool moving step, FIG. 10A shows the movement of the molten pool 56 along the abutting face 41. FIG. 10A is a perspective view showing the movement of the molten pool 56, FIG. 10B is a sectional view along a radial direction, and showing the same configuration as that of FIG. 8B. The movement of the molten pool 56 along the abutting face 41 is continuously carried out by moving the laser beam 50 at a moving irradiating start position along the abutting face 41 to the laser beam 51 at a moving irradiating end position not linearly but in a helical loop trajectory. FIG. 10A shows the helical loop trajectory 58 having a moving direction along the abutting face 41. Accordingly, the molten pool 56 is continuously formed along the abutting face while the molten state is maintained, to become a joined face 55.

Similarly, the molten pool 66 when the heat capacity is “large” and the molten pool 76 when the heat capacity is “medium” are also continuously formed along the abutting face 41 while the molten state is maintained; and as a result, the joint at the abutting face 41 is performed (S18).

What is claimed is:

1. A laser welding method for a stator coil comprising:
forming an abutting face by abutting a side face of a first lead portion of a first rectangular wire to a side face of a second rectangular wire of a second lead portion, the first rectangular wire and the second rectangular wire being conductor wires formed of conductor strands each having a rectangular cross-section and being covered with an insulation film, the insulation film at the side face of the first lead portion being peeled off and the insulation film at the side face of the second lead portion being peeled off;
defocusing of focusing a laser beam on a position more inward than a surface of an upper end of the abutting face between the first lead portion and the second lead portion;
forming a molten pool by moving the laser beam in an annular or helical loop on the upper end of the abutting face between the first lead portion and the second lead portion so as to melt the conductor wires to form the molten pool at a position closer to the upper end of the abutting face; and
moving the molten pool along the abutting face while continuously forming the molten pool, wherein
in a formation of the molten pool, when a position of a defocus depth of the laser beam is changed with time and when an output of the laser beam is changed with time, both of the position of the defocus depth and the output of the laser beam are changed continuously.
